(19) United States
(12) Patent Application Publication
(10) Pub. No.: US 2006/0048420 A1
(43) Pub. Date: Mar. 9, 2006

(54) An Improved Portable Auxiliary Vehicle/ Automobile Warning Device

(76) Inventors: Joel Fried, Brooklyn, NY (US); Joseph Just, Brooklyn, NY (US)

Correspondence Address: GREENBERG & LIEBERMAN, LLC, 2141 WISCONSIN AVE, N.W., SUITE C-2, WASHINGTON, DC, 20007, US

(21) Appl. No.: 10/710,689

(22) Filed: Jul. 28, 2004

(51) Int. Cl. G09F 21/04

(52) U.S. Cl. 40/592

(57) ABSTRACT

A warning device, and more particularly, an improved combination of message display when the driver of the vehicle is in distress. It is directed to an improved portable auxiliary vehicle/automobile warning device capable of being installed/deployed and/or removeably secured by the user by simply reaching out of the window to set the said device on the roof of the vehicle so that the user does not need to get out of the car and become injured from passing vehicles. This allows other automobiles to see the broken down vehicle to avoid collision.

### BACKGROUND OF INVENTION

The present invention generally relates to warning systems and, more particularly, to an improved auxiliary vehicle warning device capable of being placed on the roof of the vehicle as and when required and could be removed from the said place when the use of the same is over.

In all countries there is an increasing number of automobiles and other types of motor vehicles, such as trucks, vans and delivery vehicles that are crowded onto increasingly crowded roadways. There are basically two types of situations encountered by modern vehicles, first there is the high speed travel encountered on toll roads, freeways or interstate highways and second, there is the congested, crowded travel encountered mainly in cities and suburban areas. In either situation, it is becoming more and more important to increase the safety of travel to improve the quality of travel for all travelers.

Because of the high-speed travel encountered in the first situation and the congested and crowded travel encountered in the second situation it is important that as much information as possible concerning operation of a vehicle be communicated to other vehicles. In addition, it is important that as much information as possible be communicated to following vehicles concerning conditions the following vehicles will encounter. This information must be communicated quickly and easily and be clear and concise.

In view of the large number of vehicles which become disabled on the road, there is also a substantial need of an improved “disabled condition” signaling system which can be operated from the inside of the vehicle and which will be visible at a considerable distance. Such device preferably also should be capable of transmitting to drivers of other rear vehicles and other messages, such as warning to the high speed rear vehicle to slow down the speed, car stuck due to break down, call for help in need of emergency.

Over the years, many vehicle communication devices have been proposed including, in the most basic forms, fixed signs bearing appropriate messages. More recently, several signaling or communication devices have been suggested having the capability of individual selection of one of a plurality of messages for viewing externally of the vehicle. For instance, such messages may include a request of a following driver to dim lights or to avoid tailgating, to notify a following driver of road or traffic conditions ahead, to request passing drivers to send help or render assistance in an emergency, etc. Most recently, several message or communication devices have been suggested having a control unit in which messages can be programmed together with a display unit for a programmed message. However, in nearly every instance, such devices suffer from one or more serious drawbacks rendering them less than fully desirable.

In particular, such devices have usually been designed to sit on the rear deck of a vehicle in the rear window for viewing by a following motorist. This is most undesirable, however, because it interferes with normal use of an inside rearview mirror. The size and construction of such devices, as exemplified by U.S. Pat. Nos. 4,361,828 and 3,299,552, among others, create blind spots that could result in a serious accident by reason of a driver failing to see another nearby vehicle, for example, during a lane-changing maneuver. This is not a problem, however, in some of the communication devices proposed in earlier times. Unfortunately, devices such as those proposed in U.S. Pat. Nos. 2,843,952 and 2,503,336 suffer from other serious drawbacks.

In particular, the latter devices are adapted to be mounted externally of a vehicle. This either requires some permanent modification to the vehicle or greatly restricts the ability of a motorist to add the device as an aftermarket accessory and, in any event, is subject to theft, breakage, or damage or obstruction by adverse weather and road conditions. Moreover, the installation of such devices is well beyond the usual capabilities of the average motorist.

The various systems for automobile-to-automobile communication have been proposed. Generally, these involve the signaling of preselected messages from one vehicle to another in response to the manual operation of a switch to select the message to be communicated. These systems typically do not interface with the standard vehicle signaling devices. Other simple communicating devices include fixed signals with appropriate messages that are displayed somewhere on the vehicle. Some of the proposed methods include messages that are pre-programmable to be displayed at the rear of the vehicle. However, one of the problems in existing systems is that when these fixed signals are displayed there is a potential for confusing signals to be sent. There can be conflicting signals sent by the communications system to the drivers of other vehicles when the automatic signals are displayed, such as break lights or turn signals. For example, the driver of a vehicle may be displaying a fixed sign such as “SAFE TO PASS ON RIGHT”, when an emergency braking situation occurs. The driver presses the break pedal and does not have time to remove the displayed fixed sign. This situation clearly has the potential to confuse a following driver and may cause an accident.

Despite the many attempts to overcome the problems with signaling, message and communication devices, it has remained to provide a truly universal vehicle communicator capable of satisfying the requirements of motorists in an effective manner.

Accordingly, in order to improve vehicle driving safety there is a need for an improved, inexpensive, durable auxiliary visual vehicle warning device capable of being easily and detachably mounted at top of a vehicle and at a desired eye level. Such device preferably should utilize existing vehicle circuitry and be capable of being installed by any vehicle driver with few or no tools in a minimum amount of time.

### SUMMARY OF INVENTION

The present invention relates to warning devices, and more particularly concerns an improved combination of message display when the driver of the vehicle is in distress.

It is therefore an object of the present invention to provide a new and improved visual communication device, which has all the advantages of the prior art visual communication devices and none of the disadvantages.

It is another object of the present invention to provide a new and improved visual communication device, which may be easily and efficiently manufactured and marketed.

It is a further object of the present invention to provide a new and improved visual communication device, which is of a durable and reliable construction.

An even further object of the present invention is to provide a new and improved visual communication device which is susceptible of a low cost of manufacture with regard to both materials and labor, and which accordingly is then susceptible of low prices of sale to the consuming public, thereby making such visual communication devices economically available to the buying public.

Still yet another object of the present invention is to provide a new and improved visual communication device, which provides in the apparatuses and methods of the prior art some of the advantages thereof, while simultaneously overcoming some of the disadvantages normally associated therewith.

Still another object of the present invention is to provide a new and improved visual communication device wherein the same includes a display unit to be selectively mounted to exterior of an associated automobile.

The present invention is directed to an improved portable auxiliary vehicle/automobile warning device capable of being installed/deployed and/or removeably secured by the user by simply reaching out of the window to set the said device on the roof of the vehicle, comprising:

a housing containing a display panel with visual display means for providing a plurality of individually selectable messages having magnetic bottom piece;

mounting means with height control mechanism, with a grove on its top to accommodate the said bottom piece of the housing and magnetic holder at its bottom, for removeably securing the same on the roof of the vehicle;

a control unit mounted in side the vehicle with electrical circuit means for connecting the said unit to the electrical system of the vehicle, capable of being operated by the user, having a plurality of switches, each of which controls a light source in the said visual display means;

said electrical circuit means interconnects the power source, a pulse generating means, a sensor discriminator means and said visual display means.

The display unit can be installed at various locations on the roof of the vehicle.

Other objects, features, and advantages of the present invention will become apparent from the detailed description and the accompanying drawings.

### BRIEF DESCRIPTION OF DRAWINGS

FIG. 1 is a back view of the present invention mounted on the roof of an automobile.

FIG. 2 is an environmental view of the control unit.

FIG. 3 is a front view of the present invention.

FIG. 4 is a front view of an alternate embodiment of the present invention.

FIG. 5 is a front view of a breakdown of all major components of the alternate embodiment of the present invention.

FIG. 6 is a back view of the alternate embodiment of the present invention.

### DETAILED DESCRIPTION

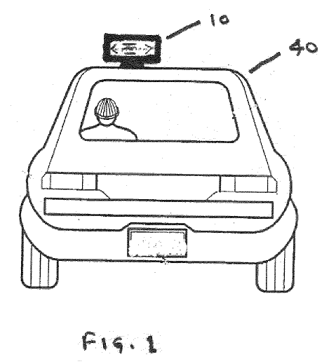

With reference now to the drawings, and in particular to FIGS. 1 to 3 thereof, a new and improved visual communication device embodying the principles and concepts of the present invention and generally designated by the reference numeral 10 will be described.

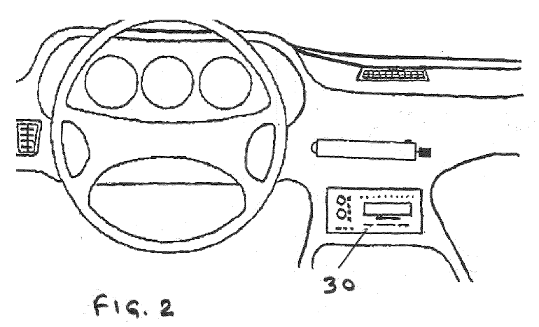

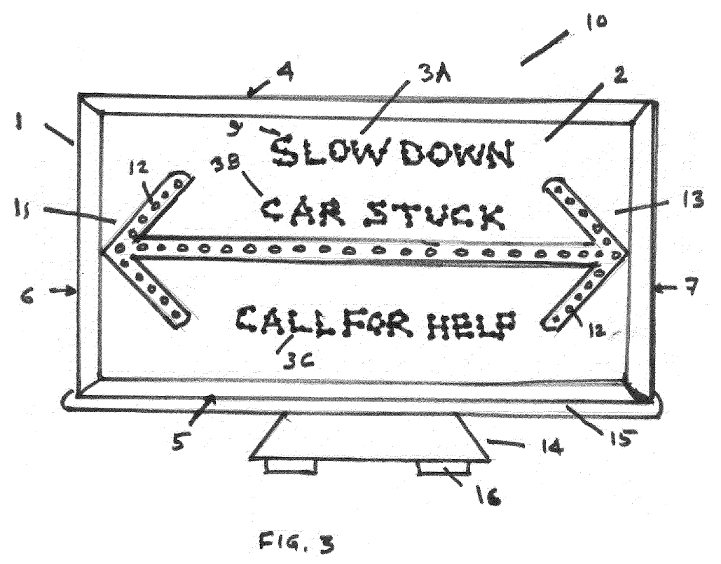

Referring now to the drawings, in which similar or corresponding parts are identified with the same reference numeral, and more particular to FIG. 1, the auxiliary signal device of the present invention is designated generally at (10) and is shown mounted on the roof of the vehicle (40). FIG. 2 is an illustration of the control unit mounted to board portion of an automobile. As shown in FIG. 3, an improved portable auxiliary vehicle/automobile warning device (10) includes a generally rectangular housing (1) having a forward display panel (2), top and bottom walls (4 and 5), end walls (6 and 7), and back panel (8) (not shown), wherein housing (1) is a three fold unit, capable of being stored in the glove compartment of the vehicle. As shown in FIG. 3, a central message display panel (2) area with visual display means for providing a plurality of individually selectable messages (3A, 3B, 3C), having magnetic bottom wall/piece (5). The said visual display means includes a plurality of small lights (9), which may be selectively illuminated as blinking neon light to form letters for messages/words or phrases. A left arrow display area (11) has a plurality of lights (12) formed in the shape of a triangle or arrow pointing to the left. A right arrow display area (13) has a plurality of lights (12) arranged to form an arrow pointing to the right. While the various display areas are shown utilizing a plurality of individual lights, various other methods for producing the desired illuminated area could be utilized, such as neon light, LEDs, liquid crystal, or the like. A mounting means (14) with height control mechanism, with a grove (15) on its top to accommodate the said bottom piece of the housing (5) and magnetic holder (16) at its bottom, for removeably securing the same on the roof of the vehicle without damaging the paint or surface of the vehicle.

An electrical cord (17) (not shown) extends from the interior of housing (1) through left end wall (6) to the electrical system of the vehicle, for connection thereto. A control unit (30), as shown in FIG. 2, mounted in side the vehicle with electrical circuit means for connecting the said unit to the electrical system of the vehicle, capable of being operated by the user, having a plurality of switches, each of which controls a light source in the said visual display means, said control unit is designed to activate predetermined display areas in response to the activation of various circuits of the vehicle electrical system. The said electrical circuit means interconnects the power source, a pulse generating means, a sensor discriminator means and said visual display means.

More specifically, control unit will activate both arrow display areas (11 and 13) simultaneously with a preprogrammed message in the message display area (2) as shown in FIG. 3. In the embodiment shown in FIG. 3, the word SLOW DOWN/CAR STUCK/CALL FOR HELP has been programmed into the control unit as the appropriate message to be displayed. Message display area (2) and arrow display areas (11 and 13) for right/left directional light signal will flash alternately, and in sequence with the conventional four-way hazard lights on the vehicle.

The rectangular housing (1) of the portable auxiliary vehicle/automobile warning device (10) doesn't exceed 11″ in length and 9″ in breadth, thus it is lightweight, compact and capable of being stored in the glove compartment of the vehicle.

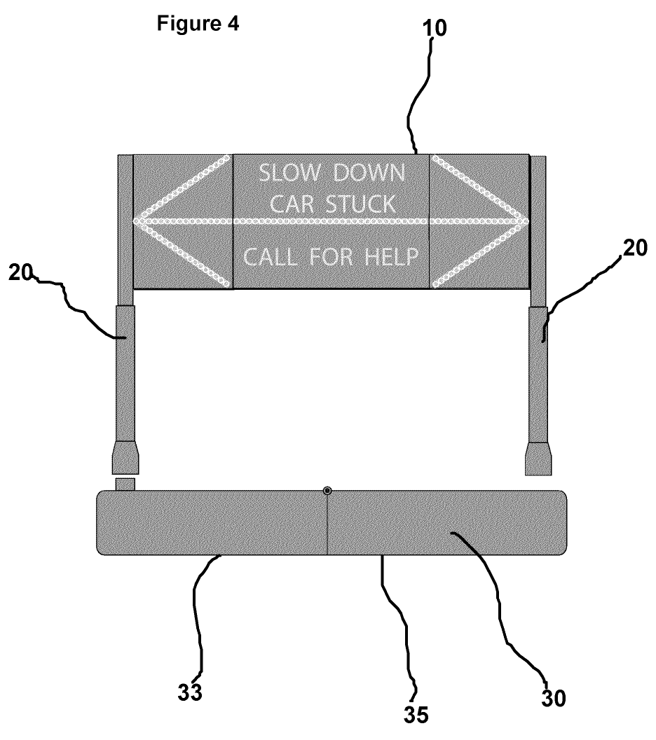

In an alternate embodiment shown in FIGS. 4-6 automobile warning device (10) will have extendable legs (20) and a stand (30). As shown in FIG. 4 extendable legs (20) attach to either side automobile warning device (10). Extendable legs (20) extend in a telescopic manner to allow automobile warning device to sit higher above the automobile using it as to provide a better view of the sign to all other traffic. Additionally, there is a stand (30), which extendable legs (20) attach to provide more stability when automobile warning device (10) is attached to the disabled automobile. Stand (30) has two magnets (33, 35) on the bottom so as to allow attachment to the disabled automobile. When not in use stand (30) can be folded in half via hinge (22) and can act as a protective case for the automobile warning device (10). Extended legs (20) slide closed and the warning device (10) can fit inside stand (30).

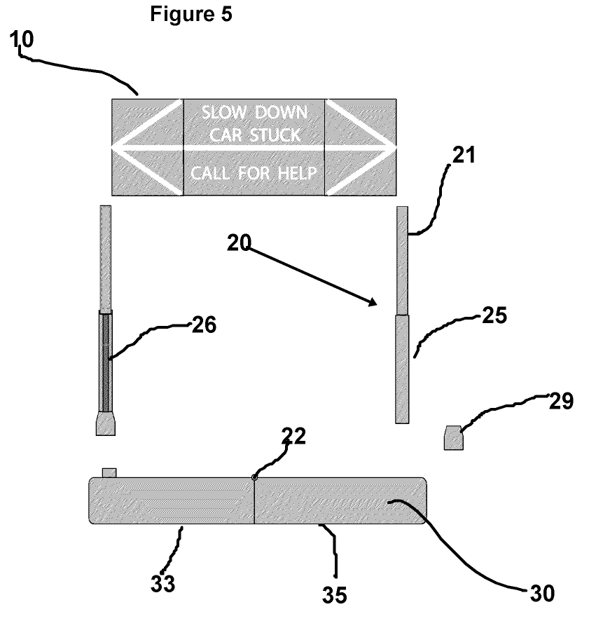

FIG. 5 shows a breakdown of all major individual components of the alternate embodiment of the automobile warning device (10). Extendable legs (20) have three different parts, upper leg (21), lower leg (25), and foot (29). Upper leg (21) directly connects to automobile warning device (10) and fits inside lower leg (25). Lower leg (25) fits over upper leg (21) and has a slot (26) running the length of it so as to receive the sides of warning device (10) when extendable legs are in the closed position. At the base of lower legs (25) are feet (29) that directly communicate with stand (30).

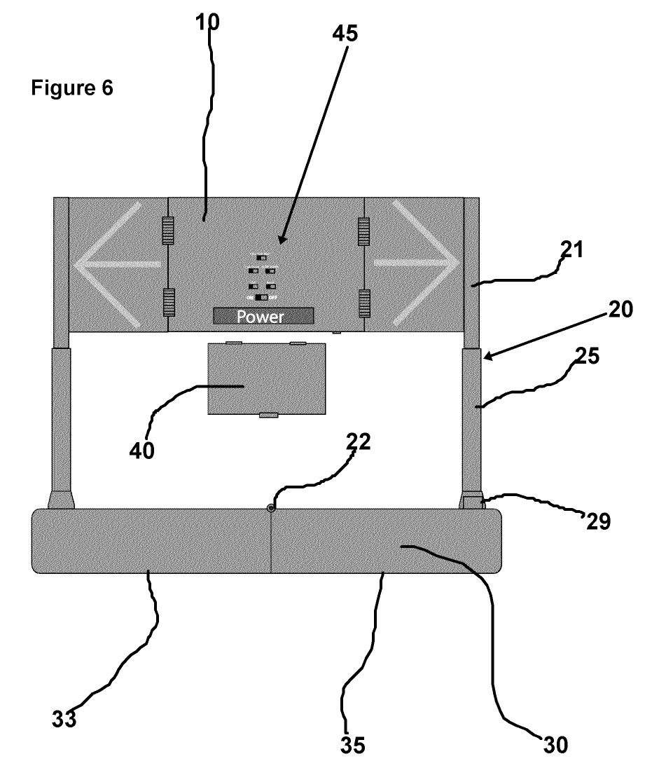

FIG. 6 shows the power source and control panel of the alternate embodiment of the automobile warning device (10). The alternate embodiment of the automobile warning device (10) is powered by a conventional battery which is in a conventional battery receptacle (not shown) covered with a conventional battery receptacle cover (40). There are a series of switches (45) that control the displays (3A, 3B, 3C, 11, 13) as desired and must be manually selected.

The said right/left directional light signal will be flashed depending upon the position of the broken down vehicle in the road and indication to following vehicles and other automobiles to see the broken down vehicle and to overtake it from the direction indicated being safe to pass on, so as to avoid collision.

With respect to the above descriptions then the manner of usage and operation of the present invention, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1-10. (canceled)

11. A portable auxiliary vehicle/automobile warning device capable of being installed/deployed and/or removeably secured by the user by simply reaching out of the window to set the device on the roof of the vehicle, comprising:
a flexible housing;
a visual display means on said housing, said visual display means for providing at least one message; and
a means for removeably securing said housing to the roof of the vehicle;
wherein said housing and said visual display means are waterproof and configured to be manipulated by a single hand of the user.

12. The device of claim 11, wherein said housing is partitioned into separate joined sections.

13. The device of claim 12, wherein said separate joined sections number three.

14. The device of claim 12, wherein said separate joined sections fold upon one another.

15. The device of claim 11, wherein said visual display means is a series of light emitting diodes.

16. The device of claim 15, wherein said light emitting diodes are recessed into said housing.

17. The device of claim 16, wherein said light emitting diodes are completely recessed into said housing.

18. The device of claim 14, wherein said visual display means is a series of light emitting diodes that are completely recessed into said housing so that said light emitting diodes are not broken when said separate joined sections fold upon one another.

19. The device of claim 11, wherein said housing, said visual display means, and said means for removeably securing said housing to the roof of the vehicle is lightweight.

20. The device of claim 11, wherein said means for removeably securing said housing to the roof of the vehicle maintains said housing in an upright position, perpendicular to the horizontal plane of the roof of the vehicle.

21. The device of claim 11, wherein said housing is water resistant.

22. The device of claim 11 wherein said visual display means is waterproof or water resistant.

23. The device of claim 11, wherein said means for removeably securing said housing to the roof of the vehicle is waterproof or water resistant.

24. The device of claim 11, wherein said housing is small enough to fit in the glove compartment of a conventional automobile measuring roughly 1½ feet by 1 foot.
